(19) United States
(12) Patent Application Publication
(10) Pub. No.: US 2025/0253313 A1
(43) Pub. Date: Aug. 7, 2025

(54) EVALUATION METHOD AND PRODUCTION METHOD FOR SLURRY FOR BATTERIES, METHOD FOR PRODUCING BATTERY, AND SLURRY FOR BATTERIES

(71) Applicant: TOYOTA JIDOSHA KABUSHIKI KAISHA, Toyota-shi (JP)

(72) Inventors: Manabu IMANO, Nagoya-shi (JP); Kazuki MURAISHI, Toyota-shi (JP)

(73) Assignee: TOYOTA JIDOSHA KABUSHIKI KAISHA, Toyota-shi (JP)

(21) Appl. No.: 19/008,231

(22) Filed: Jan. 2, 2025

(30) Foreign Application Priority Data
Feb. 2, 2024 (JP) 2024-014952

(51) Int. Cl. H01M 4/139; G01N 24/08; H01M 4/02; H01M 4/04; H01M 10/0525

(52) U.S. Cl. CPC H01M 4/139; G01N 24/085; H01M 4/0407; H01M 10/0525; H01M 2004/027; H01M 2004/028; H01M 2300/0065

(57) ABSTRACT

The present disclosure provides an evaluation method and production method for a slurry for batteries designed to obtain a coated film with satisfactory properties, a method for producing a battery that includes producing the slurry for batteries, and a slurry for batteries that can yield a coated film with satisfactory properties. The method of the disclosure for evaluating a slurry for batteries comprises measuring the relaxation time of the slurry using a TDNMR apparatus to evaluate the dispersity of specific components. The method of the disclosure for producing a slurry for batteries comprises evaluating the dispersity of the specific component.

### FIELD

The present disclosure relates to an evaluation method and production method for a slurry for batteries, to a method for producing a battery, and to a slurry for batteries.

### BACKGROUND

A technique for measuring the dispersity of components in solid-state battery slurry compositions by a fineness gauge method is known, as disclosed in PTL 1.

### CITATION LIST

### Literature

[PTL 1] International Patent Publication No. WO2020/241322

### SUMMARY

### Technical Problem

For production of a battery, it is preferred to be able to predict the properties of a coated film that is obtained by coating and drying the slurry for the battery, based on the properties of the slurry. The present inventors have found that even when the dispersity of components in the slurry for batteries is below a given threshold when measured by the fineness gauge method, it is sometimes the case that coarse particles remain on the coated film, i.e. that the properties of the coated film are unsatisfactory.

It is an object of the present disclosure to provide an evaluation method and production method for a slurry for batteries designed to obtain a coated film with satisfactory properties, a method for producing a battery that includes producing the slurry for batteries, and a slurry for batteries that can yield a coated film with satisfactory properties.

### Solution to Problem

The present inventors have found that this object can be achieved by the following means.

### <Aspect 1>

An evaluation method for a slurry for batteries, comprising measuring the relaxation time of the slurry for batteries using a time-domain nuclear magnetic resonance apparatus to evaluate the dispersity of specific components contained in the slurry for batteries.

### <Aspect 2>

The method according to aspect 1, wherein the slurry for batteries is a negative electrode mixture slurry, and the specific component is a negative electrode active material.

### <Aspect 3>

The method according to aspect 2, wherein the relaxation time is measured by the CPMG method.

### <Aspect 4>

A method for producing a negative electrode mixture slurry, the method comprising the following steps:
(a) providing a preliminary negative electrode mixture slurry containing a negative electrode active material and a dispersing medium,
(b) stirring the preliminary negative electrode mixture slurry, and
(c) evaluating the dispersity of the negative electrode active material in the negative electrode mixture slurry by the method according to aspect 2.

### <Aspect 5>

The method according to aspect 4, wherein in step (c), steps (b) and (c) are repeated until the converted value of the relaxation time of the negative electrode mixture slurry as measured by the CPMG method is 0.015 or more and 0.025 or less, in terms calculated based on the relaxation time of the dispersing medium.

### <Aspect 6>

The method according to aspect 4, wherein the mean particle diameter of the negative electrode active material is 10 nm or more and 50 μm or less.

### <Aspect 7>

A method for producing a battery, comprising the following steps:
providing a negative electrode mixture slurry by the method according to any one of aspects 4 to 6, and
coating the negative electrode mixture slurry onto a substrate and drying and removing the dispersing medium to form a negative electrode active material layer.

### <Aspect 8>

A negative electrode mixture slurry wherein the converted value of the relaxation time as measured by the CPMG method using a time-domain nuclear magnetic resonance apparatus, is 0.015 or more and 0.025 or less in terms calculated based on the relaxation time of the dispersing medium.

### <Aspect 9>

The method according to aspect 1, wherein the slurry for batteries is a solid electrolyte mixture slurry, and the specific component is a solid electrolyte.

### <Aspect 10>

The method according to aspect 9, wherein the relaxation time is measured by the CPMG method.

### <Aspect 11>

A method for producing a solid electrolyte mixture slurry, the method comprising the following steps:
(a) providing a preliminary solid electrolyte mixture slurry containing a solid electrolyte and a dispersing medium,
(b) stirring the preliminary solid electrolyte mixture slurry, and
(c) evaluating the dispersity of the solid electrolyte in the solid electrolyte mixture slurry by the method according to aspect 9.

### <Aspect 12>

The method according to aspect 11, wherein in step (c), steps (b) and (c) are repeated until the converted value of the relaxation time of the solid electrolyte mixture slurry as measured by the CPMG method is 0.45 or more and 0.50 or less, in terms calculated based on the relaxation time of the dispersing medium.

### <Aspect 13>

The method according to aspect 11, wherein the mean particle diameter of the solid electrolyte is 1 nm or more and 10 μm or less.

### <Aspect 14>

A method for producing a battery, comprising the following steps:
providing a solid electrolyte mixture slurry by the method according to any one of aspects 11 to 13, and
coating the solid electrolyte mixture slurry onto a substrate and drying and removing the dispersing medium to form a solid electrolyte layer.

### <Aspect 15>

A solid electrolyte mixture slurry wherein the converted value of the relaxation time as measured by the CPMG method using a time-domain nuclear magnetic resonance apparatus, is 0.45 or more and 0.50 or less in terms calculated based on the relaxation time of the dispersing medium.

### <Aspect 16>

The method according to aspect 1, wherein the slurry for batteries is a positive electrode mixture slurry, and the specific component is a positive electrode active material.

### <Aspect 17>

The method according to aspect 16, wherein the relaxation time is measured by the solid echo method.

### <Aspect 1822

A method for producing a positive electrode mixture slurry, the method comprising the following steps:
(a) providing a preliminary positive electrode mixture slurry containing a positive electrode active material and a dispersing medium,
(b) stirring the preliminary positive electrode mixture slurry, and
(c) evaluating the dispersity of the positive electrode active material in the positive electrode mixture slurry by the method according to aspect 16.

### <Aspect 19>

The method according to aspect 18, wherein in step (c), steps (b) and (c) are repeated until the converted value of the relaxation time of the positive electrode mixture slurry as measured by the solid echo method, is 4.5×10⁻⁵ or more and 5.4×10⁻⁵ or less, in terms calculated based on the relaxation time of the dispersing medium.

### <Aspect 20>

The method according to aspect 18, wherein the mean particle diameter of the positive electrode active material is 10 nm or more and 50 μm or less.

### <Aspect 21>

A method for producing a battery, comprising the following steps:
providing a positive electrode mixture slurry by the method according to any one of aspects 18 to 20, and
coating the positive electrode mixture slurry onto a substrate and drying and removing the dispersing medium to form a positive electrode active material layer.

### <Aspect 22>

A positive electrode mixture slurry wherein the converted value of the relaxation time as measured by the solid echo method using a time-domain nuclear magnetic resonance apparatus, is 4.5×10⁻⁵ or more and 5.4×10⁻⁵ or less, in terms calculated based on the relaxation time of the dispersing medium.

### Advantageous Effects of Invention

The present disclosure can provide an evaluation method and production method for a slurry for batteries designed to obtain a coated film with satisfactory properties, a method for producing a battery that includes producing the slurry for batteries, and a slurry for batteries that can yield a coated film with satisfactory properties.

### DESCRIPTION OF EMBODIMENTS

Hereinafter, embodiments of the present disclosure will be described in detail. It should be noted that the present disclosure is not limited to the following embodiments, and various modifications can be made thereto within the scope of the disclosure.

As mentioned above, the present inventors found that even when the dispersity of components in the slurry for batteries is below a given threshold when measured by the fineness gauge method, it is sometimes the case that coarse particles remain on the coated film, i.e. that the properties of the coated film are unsatisfactory.

In this regard, the present inventors considered that one of the causes of unsatisfactory properties of the coated film even if the dispersity is below the threshold as measured by the fineness gauge method, is that mechanical force acts on the slurry during measurement by the fineness gauge method. Without being restricted to any particular theory, the reason for this is conjectured to be as follows. Measurement by the fineness gauge method includes a step of scraping the surface of the slurry-filled grind gauge with a scraper. Application of shear force to the slurry during this time causes the components contained in the slurry to undergo deformation and deagglomeration, making it impossible to accurately measure the dispersity of the slurry components and thus making it impossible to accurately predict the properties of the resulting coated film. In other words, in a slurry for batteries, the properties of the obtained active material layer are affected even with aggregates that readily undergo deformation and deagglomeration by shear force during measurement by the fineness gauge method.

In this regard, the present inventors found that if the relaxation time measured using a time-domain nuclear magnetic resonance (TDNMR) apparatus is used as an index of the dispersity of specific components in a slurry, and the relaxation time is within a predetermined range, then the coated film exhibits satisfactory properties. Without being restricted to any particular theory, the reason for this is conjectured to be as follows. Specifically, the slurry is not subjected to excessively strong mechanical force in measurement using a TDNMR apparatus, unlike in measurement by the fineness gauge method. This is thought to help prevent the components in the slurry from undergoing deformation and deagglomeration, thus allowing more accurate evaluation of the dispersity of the slurry components. Accurate evaluation of the dispersity of the components in a slurry for batteries can allow accurate prediction of the properties of the active material layer that is obtained.

For the purpose of the present disclosure, the term “relaxation time” means the transverse relaxation time (spin-spin relaxation time) T₂.

According to the disclosure it is possible to evaluate the dispersity of particles of a specific component in a slurry for batteries, based on the motility of the solvent molecules. Specifically, a greater number of solvent molecules constrained by the particles shortens the measured relaxation time (T₂), corresponding to higher dispersity. On the other hand, a greater number of solvent molecules in a freer state than the solvent molecules constrained by the particles lengthens the measured relaxation time (T₂), corresponding to lower dispersity. The difference in dispersity of the particles in the slurry can therefore be expressed as the length of the relaxation time (T₂).

The term “slurry for batteries” is used herein to include the concept of a negative electrode mixture slurry, a solid electrolyte mixture slurry and a positive electrode mixture slurry.

### <Evaluation Method for Negative Electrode Mixture Slurry>

The method of the disclosure for evaluating a negative electrode mixture slurry comprises measuring the relaxation time of the negative electrode mixture slurry using a time-domain nuclear magnetic resonance (TDNMR) apparatus to evaluate the dispersity of the negative electrode active material contained in the negative electrode mixture slurry. This allows accurate evaluation of the dispersity of the negative electrode active material in the negative electrode mixture slurry.

The TDNMR apparatus used in the method of the disclosure may be a Minispec mq20 by Bruker Co., for example. The relaxation time can be calculated in terms of the indicated value using the TDNMR-A data analysis software included with the TDNMR apparatus. Specifically, the ratio of the relaxation time of the negative electrode mixture slurry is calculated with respect to the relaxation time of the dispersing medium used to prepare the negative electrode mixture slurry, to obtain the desired value. The same also applies for other battery slurry evaluation methods used according to the present disclosure.

According to the present disclosure, the relaxation time may be measured by the CPMG method. The CPMG method, as referred to herein, is a method in which a 90° pulse is first applied to create transverse magnetization, with relaxation during t, and then a 180° pulse is applied for phase inversion to generate a resonance signal echo, and the signal strength at that time is measured.

### <Method for Producing Negative Electrode Mixture Slurry>

The method for producing a negative electrode mixture slurry according to the disclosure comprises the following steps: (a) providing a preliminary negative electrode mixture slurry containing a negative electrode active material and a dispersing medium, (b) stirring the preliminary negative electrode mixture slurry, and (c) evaluating the dispersity of the negative electrode active material in the negative electrode mixture slurry by the method for evaluating a negative electrode mixture slurry according to the disclosure. If the dispersity of the negative electrode active material in the negative electrode mixture slurry is evaluated in the method for evaluating a negative electrode mixture slurry according to the disclosure, then a coated film with satisfactory properties can be obtained after the produced negative electrode mixture slurry has been used to form a coated film.

### <Step of Providing Preliminary Negative Electrode Mixture Slurry>

The method for producing a negative electrode mixture slurry according to the disclosure comprises: (a) providing a preliminary negative electrode mixture slurry containing a negative electrode active material and a dispersing medium.

### (Negative Electrode Active Material)

The negative electrode active material used may be a substance that exhibits electronegative potential for positive electrode active materials. Such a negative electrode active material may be a publicly known active material, and when constructing a lithium ion battery, for example, it may be silicon or a silicon-based active material such as silicon alloy or silicon oxide as the negative electrode active material; a carbon-based active material such as graphite or hard carbon; an oxide-based active material such as lithium titanate; or lithium metal or lithium alloy.

The mean particle diameter of the negative electrode active material may be 10 nm or more and 50 μm or less. The mean particle diameter of the negative electrode active material may be 100 nm or more or 500 nm or more, and 30 μm or less or 10 μm or less. The mean particle diameter of the negative electrode active material can be determined as the average for the circle equivalent diameter of the negative electrode active material in a scanning electron microscope (SEM) image, for example. The mean particle diameter can also be measured by the same method for the solid electrolyte and positive electrode active material described below.

### (Dispersing Medium)

The dispersing medium may be a nonpolar solvent or polar solvent, or a combination of both. Examples of nonpolar solvents include heptane, xylene and toluene, as well as their combinations. Examples of polar solvents include tertiary amine-based solvents such as triethylamine, ether-based solvents such as cyclopentylmethyl ether, thiol-based solvents such as ethanemercaptane, and ester-based solvents such as butyl butyrate, as well as their combinations.

### <Step of Stirring Preliminary Negative Electrode Mixture Slurry>

The method of the disclosure comprises (b) a step of stirring the preliminary negative electrode mixture slurry.

The method of stirring the preliminary negative electrode mixture slurry is not particularly restricted, and for example, a method of mixing with an ultrasonic disperser, a method of mixing with a stirring blade, or a method of mixing with a combination of these, may be used. This method may also be applied for production of the other battery slurries mentioned herein.

### <Evaluation Step>

The method for producing a negative electrode mixture slurry according to the disclosure includes (c) evaluating the dispersity of the negative electrode active material in the negative electrode mixture slurry by the method for evaluating a negative electrode mixture slurry according to the disclosure.

The method for evaluating a negative electrode mixture slurry according to the disclosure may be carried out with reference to the aforementioned method for evaluating a negative electrode mixture slurry according to the disclosure.

In the method for producing a negative electrode mixture slurry according to the disclosure, in step (c), steps (b) and (c) may be repeated until the converted value of the relaxation time of the negative electrode mixture slurry as measured by the CPMG method is 0.015 or more and 0.025 or less, in terms calculated based on the relaxation time of the dispersing medium.

### <Negative Electrode Mixture Slurry>

In the negative electrode mixture slurry of the disclosure, the converted value of the relaxation time as measured by the CPMG method using a time-domain nuclear magnetic resonance apparatus, is 0.015 or more and 0.025 or less in terms calculated based on the relaxation time of the dispersing medium.

The relative value may be 0.015 or more, 0.016 or more, 0.017 or more or 0.018 or more, and 0.025 or less. If the relative value is within the aforementioned range it will be possible to obtain a coated film with satisfactory properties.

### <Evaluation Method for Solid Electrolyte Mixture Slurry>

The method of the disclosure for evaluating a solid electrolyte mixture slurry comprises measuring the relaxation time of the solid electrolyte mixture slurry using a time-domain nuclear magnetic resonance apparatus to evaluate the dispersity of the solid electrolyte contained in the solid electrolyte mixture slurry. This allows accurate evaluation of the dispersity of the solid electrolyte in the solid electrolyte mixture slurry.

In the method of the disclosure for evaluating the solid electrolyte mixture slurry, the relaxation time may be measured by the CPMG method. The CPMG method may be carried out with reference to the aforementioned method for evaluating a negative electrode mixture slurry according to the disclosure.

### <Method for Producing Solid Electrolyte Mixture Slurry>

The method of the disclosure for producing a solid electrolyte mixture slurry comprises the following steps: (a) providing a preliminary solid electrolyte mixture slurry containing a solid electrolyte and a dispersing medium, (b) stirring the preliminary solid electrolyte mixture slurry, and (c) evaluating the dispersity of the solid electrolyte in the solid electrolyte mixture slurry by the method for evaluating a solid electrolyte mixture slurry according to the disclosure. If the dispersity of the solid electrolyte in the solid electrolyte mixture slurry is evaluated in the method for evaluating a solid electrolyte mixture slurry according to the disclosure, then a coated film with satisfactory properties can be obtained after the produced solid electrolyte mixture slurry has been used to form a coated film.

### <Step of Providing Preliminary Solid Electrolyte Mixture Slurry>

The method for producing a solid electrolyte mixture slurry according to the disclosure comprises: (a) providing a preliminary solid electrolyte mixture slurry containing a solid electrolyte and a dispersing medium.

### (Solid Electrolyte)

For example, the material of the solid electrolyte may be a sulfide solid electrolyte, an oxide solid electrolyte or a polymer electrolyte, although this is not limitative.

Examples of sulfide solid electrolytes include, but are not limited to, sulfide-based amorphous solid electrolytes, sulfide-based crystalline solid electrolytes and argyrodite solid electrolytes. Specific examples of sulfide solid electrolytes include, but are not limited to, Li₂S-P₂S₅ (Li₇P₃S₁₁, Li₃PS₄, Li₈P₂S₉), Li₂S-SiS₂, LiI-Li₂S-SiS₂, LiI-Li₂S-P₂S₅, LiI-LiBr-Li₂S-P₂S₅, Li₂S-P₂S₅-GeS₂ (Li₁₃GeP₃S₁₆, Li₁₀GeP₂S₁₂), LiI-Li₂S-P₂O₅, LiI-Li₃PO₄-P₂S₅ and Li7-ₓPS₆₋ₓClₓ, as well as combinations thereof.

Examples of oxide solid electrolytes include, but are not limited to, Li₇La₃Zr₂O₁₂, Li₇-ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂-ₓ(PO₄)₃, Li₃PO₄ and Li₃₊ₓPO₄₋ₓNₓ(LiPON).

The sulfide solid electrolyte and oxide solid electrolyte may be glass or crystallized glass (glass ceramic).

Polymer electrolytes include, but are not limited to, polyethylene oxide (PEO) and polypropylene oxide (PPO), and their copolymers.

The mean particle diameter of the solid electrolyte may be 1 nm or more and 10 μm or less The mean particle diameter of the solid electrolyte may be 10 nm or more or 100 nm or more, and 5 μm or less or 3 μm or less.

### (Dispersing Medium)

The dispersing medium may be one prepared with reference to the aforementioned method for producing a negative electrode mixture slurry according to the disclosure.

### <Step of Stirring Preliminary Solid Electrolyte Mixture Slurry>

The method for producing a solid electrolyte mixture slurry according to the disclosure also comprises: (b) stirring the preliminary solid electrolyte mixture slurry.

### <Evaluation Step>

The method for producing a solid electrolyte mixture slurry according to the disclosure also comprises (c) evaluating the dispersity of the solid electrolyte in the solid electrolyte mixture slurry by the method for evaluating a solid electrolyte mixture slurry according to the disclosure.

The method for evaluating a solid electrolyte mixture slurry according to the disclosure may be carried out with reference to the aforementioned method for evaluating a solid electrolyte mixture slurry according to the disclosure.

In the method for producing a solid electrolyte mixture slurry according to the disclosure, in step (c), steps (b) and (c) may be repeated until the converted value of the relaxation time of the solid electrolyte mixture slurry as measured by the CPMG method is 0.45 or more and 0.50 or less, in terms calculated based on the relaxation time of the dispersing medium.

### <Solid Electrolyte Mixture Slurry>

In the solid electrolyte mixture slurry of the disclosure, the converted value of the relaxation time as measured by the CPMG method using a time-domain nuclear magnetic resonance apparatus, is 0.45 or more and 0.50 or less in terms calculated based on the relaxation time of the dispersing medium.

The relative value may be 0.45 or more or 0.46 or more, and 0.50 or less or 0.49 or less. If the calculated value is within the aforementioned range it will be possible to obtain a coated film with satisfactory properties.

### <Evaluation Method for Positive Electrode Mixture Slurry>

The method for evaluating a positive electrode mixture slurry according to the disclosure comprises measuring the relaxation time of the positive electrode mixture slurry using a time-domain nuclear magnetic resonance apparatus to evaluate the dispersity of the positive electrode active material contained in the positive electrode mixture slurry. This allows accurate evaluation of the dispersity of the positive electrode active material in the positive electrode mixture slurry.

In the method for evaluating a positive electrode mixture slurry according to the disclosure, the relaxation time may be measured by the solid echo method. For the purpose of the disclosure, the solid echo method is a method in which a 90° pulse is first applied to create transverse magnetization, and then in order to eliminate the apparent unobservable time of the measuring device, the phase is varied 90° to apply a second 90° pulse to generate an echo, and the signal strength at that time is measured.

### <Method for Producing Positive Electrode Mixture Slurry>

The method for producing a positive electrode mixture slurry according to the disclosure comprises the following steps: (a) providing a preliminary positive electrode mixture slurry containing a positive electrode active material and a dispersing medium, (b) stirring the preliminary positive electrode mixture slurry, and (c) evaluating the dispersity of the positive electrode active material in the positive electrode mixture slurry by the method for evaluating a positive electrode mixture slurry according to the disclosure. If the dispersity of the positive electrode active material in the positive electrode mixture slurry is evaluated in the method for evaluating a positive electrode mixture slurry according to the disclosure, then a coated film with satisfactory properties can be obtained after the produced positive electrode mixture slurry has been used to form a coated film.

### <Step of Providing Preliminary Positive Electrode Mixture Slurry>

The method for producing a positive electrode mixture slurry according to the disclosure comprises: (a) providing a preliminary positive electrode mixture slurry containing a positive electrode active material and a dispersing medium.

### (Positive Electrode Active Material)

The positive electrode active material used may be a substance that exhibits electropositive potential for negative electrode active materials. Publicly known active materials may be used for the positive electrode active material. Examples of positive electrode active materials include, for construction of a lithium ion battery, lithium-containing complex oxides such as lithium cobaltate, lithium nickelate, LiNi_{1/3}Co_{1/3}Mn_{1/3}O₂, lithium manganate or spinel-based lithium compounds. Lithium ferrophosphate (LFP) may be used as an olivine-type positive electrode active material.

The mean particle diameter of the positive electrode active material may be 10 nm or more and 50 μm or less. The mean particle diameter of the positive electrode active material may be 100 nm or more or 500 nm or more, and 30 μm or less or 10 μm or less.

### (Dispersing Medium)

The dispersing medium may be one prepared with reference to the aforementioned method for producing a negative electrode mixture slurry according to the disclosure.

### <Step of Stirring Preliminary Positive Electrode Mixture Slurry>

The method for producing a positive electrode mixture slurry according to the disclosure also comprises: (b) stirring the preliminary positive electrode mixture slurry.

### <Evaluation Step>

The method for producing a positive electrode mixture slurry according to the disclosure comprises (c) evaluating the dispersity of the positive electrode active material in the positive electrode mixture slurry by the method for evaluating a positive electrode mixture slurry according to the disclosure.

The method for evaluating a positive electrode mixture slurry according to the disclosure may be carried out with reference to the aforementioned method for evaluating a positive electrode mixture slurry according to the disclosure.

In the method for producing a positive electrode mixture slurry according to the disclosure, in step (c), steps (b) and (c) may be repeated until the converted value of the relaxation time of the positive electrode mixture slurry as measured by the solid echo method is 4.5×10⁻⁵ or more and 5.4×10⁻⁵ or less, in terms calculated based on the relaxation time of the dispersing medium.

### <Positive Electrode Mixture Slurry>

In the positive electrode mixture slurry of the present disclosure, the converted value of the relaxation time as measured by the solid echo method using a time-domain nuclear magnetic resonance apparatus, is 4.5×10⁻⁵ or more and 5.4×10⁻⁵ or less, in terms calculated based on the relaxation time of the dispersing medium.

The relative value may be 4.5×10⁻⁵ or more, 4.6×10⁻⁵ or more or 4.7×10⁻⁵ or more, and 5.4×10⁻⁵ or less, 5.3×10⁻⁵ or less or 5.2×10⁻⁵ or less. If the relative value is within the aforementioned range it will be possible to obtain a coated film with satisfactory properties.

### <Other Components>

The preliminary negative electrode mixture slurry and preliminary positive electrode mixture slurry may also optionally include a solid electrolyte. In this case the mean particle diameter of the solid electrolyte may be smaller than the mean particle diameter of the negative electrode active material and positive electrode active material. With such a construction it is possible to accurately evaluate the dispersity of the negative electrode active material in the negative electrode mixture slurry and the positive electrode active material in the positive electrode mixture slurry. The solid electrolyte may be prepared with reference to the method for producing a solid electrolyte mixture slurry according to the disclosure.

The preliminary negative electrode mixture slurry, preliminary solid electrolyte mixture slurry and preliminary positive electrode mixture slurry may optionally further include a conductive aid and a binder.

### (Conductive Aid)

The conductive aid is not particularly restricted. The conductive aid may be, but is not limited to, vapor-deposited carbon fiber (VGCF), acetylene black (AB), Ketjen black (KB), carbon nanotubes (CNT) or carbon nanofibers (CNF). The conductive aid may be particulate or filamentous, for example, and its size is not particularly restricted. The conductive aid is not particularly restricted but may be of a single type alone, or two or more different types may be used in combination.

### (Binder)

The binder is not particularly restricted so long as it can generally be used as a binder in an electrode active material layer. Examples include, but are not limited to, materials such as polyvinylidenefluoride-hexafluoropropylene copolymer (PVDF-co-HEP), polyvinylidene fluoride (PVDF), polytetrafluoroethylene (PTFE), polyacrylic acid, polyacrylonitrile, polymethyl methacrylate, polyvinyl alcohol, polyvinylpyrrolidone, carboxymethyl cellulose (CMC), hydroxypropyl cellulose, regenerated cellulose, polyethylene, polypropylene, starch, butadiene rubber (BR), styrene-butadiene rubber (SBR) and fluorine rubber, and combinations of the same.

### <Method for Producing Battery>

According to one embodiment, the method for producing a battery according to the disclosure comprises the following steps: providing a negative electrode mixture slurry by the method for producing a negative electrode mixture slurry according to the disclosure, and coating the negative electrode mixture slurry onto a substrate and drying and removing the dispersing medium to form a negative electrode active material layer. This method allows production of a battery comprising a coated film (negative electrode active material layer) with satisfactory properties.

### <Step of Providing Negative Electrode Mixture Slurry>

The method for producing a battery according to the disclosure comprises providing a negative electrode mixture slurry by the method for producing a negative electrode mixture slurry according to the disclosure. The method for producing a negative electrode mixture slurry according to the disclosure may be carried out with reference to the method for producing a negative electrode mixture slurry according to the disclosure.

### <Step of Forming Negative Electrode Active Material Layer>

The method for producing a battery according to the disclosure comprises coating the negative electrode mixture slurry onto a substrate and drying and removing the dispersing medium to form a negative electrode active material layer.

### (Substrate)

The substrate is not particularly restricted and may be a negative electrode collector, for example.

### (Dispersing Medium)

The dispersing medium may be one prepared with reference to the aforementioned method for producing a negative electrode mixture slurry according to the disclosure.

The method of coating the negative electrode mixture slurry onto the substrate is not particularly restricted and may be a method of coating by the blade method. The method can also be applied in a method for producing a battery according to the other embodiments described below.

The method for drying and removing the dispersing medium of the negative electrode mixture slurry is not particularly restricted, and it may be a method of using a hot plate to dry the coated film obtained by coating the negative electrode mixture slurry, for example. The drying temperature and drying time may be appropriately set depending on the boiling point and amount of the dispersing medium that is used. The method can also be applied in a method for producing a battery according to the other embodiments described below.

According to another embodiment, the method for producing a battery according to the disclosure comprises the following steps: providing a solid electrolyte mixture slurry by the method for producing a solid electrolyte mixture slurry according to the disclosure, and coating the solid electrolyte mixture slurry onto a substrate and drying and removing the dispersing medium to form a solid electrolyte layer. This method allows production of a battery comprising a coated film (solid electrolyte layer) with satisfactory properties.

### <Step of Providing Solid Electrolyte Mixture Slurry>

The method for producing a battery according to the disclosure comprises providing a solid electrolyte mixture slurry by the method for producing a solid electrolyte mixture slurry according to the disclosure. The method for producing a solid electrolyte mixture slurry according to the disclosure may be carried out with reference to the method for producing a solid electrolyte mixture slurry according to the disclosure.

### <Step of Forming Solid Electrolyte Layer>

The method for producing a battery according to the disclosure comprises coating the solid electrolyte mixture slurry onto a substrate and drying and removing the dispersing medium to form a solid electrolyte layer.

### (Substrate)

The substrate is not particularly restricted, and for example, it may be a metal foil such as an aluminum foil that is releasable after coating and drying.

### (Dispersing Medium)

The dispersing medium may be one prepared with reference to the aforementioned method for producing a negative electrode mixture slurry according to the disclosure.

According to another embodiment, the method for producing a battery according to the disclosure comprises the following steps: providing a positive electrode mixture slurry by the method for producing a positive electrode mixture slurry according to the disclosure, and coating the positive electrode mixture slurry onto a substrate and drying and removing the dispersing medium to form a positive electrode active material layer. This method allows production of a battery comprising a coated film (positive electrode active material layer) with satisfactory properties.

### <Step of Providing Positive Electrode Mixture Slurry>

The method for producing a battery according to the disclosure comprises providing a positive electrode mixture slurry by the method for producing a positive electrode mixture slurry according to the disclosure. The method for producing a positive electrode mixture slurry according to the disclosure may be carried out with reference to the method for producing a positive electrode mixture slurry according to the disclosure.

### <Step of Forming Positive Electrode Active Material Layer>

The method for producing a battery according to the disclosure comprises coating the positive electrode mixture slurry onto a substrate and drying and removing the dispersing medium to form a positive electrode active material layer.

### (Substrate)

The substrate is not particularly restricted and may be a positive electrode collector, for example.

### (Dispersing Medium)

The dispersing medium may be one prepared with reference to the aforementioned method for producing a negative electrode mixture slurry according to the disclosure.

### <Battery>

The battery obtained by the method for producing a battery according to the disclosure has at least one layer, from among a negative electrode active material layer, a solid electrolyte layer and a positive electrode active material layer. The battery obtained by the method for producing a battery according to the disclosure may also have a negative electrode current collector, a negative electrode active material layer, a solid electrolyte layer, a positive electrode active material layer and a positive electrode collector in that order.

A battery obtained by a method comprising a step of providing a negative electrode mixture slurry and a step of forming a negative electrode active material layer, or a battery obtained by a method comprising a step of providing a positive electrode mixture slurry and a step of forming a positive electrode active material layer, may be a liquid battery comprising an electrolyte solution as the electrolyte layer, or a solid-state battery comprising a solid electrolyte layer as the electrolyte layer. The battery obtained by a method comprising a step of providing a solid electrolyte mixture slurry and a step of forming a solid electrolyte layer may also be a solid-state battery. The term “solid-state battery” as used herein refers to a battery using at least a solid electrolyte as the electrolyte, and the solid-state battery may employ a combination of a solid electrolyte and a liquid electrolyte as the electrolyte. The solid-state battery of the disclosure may also be an all-solid-state battery, i.e. a battery employing only a solid electrolyte as the electrolyte.

The battery obtained by the method for producing a battery according to the disclosure may be a primary battery or a secondary battery. Secondary batteries include, for example, lithium ion batteries and sodium ion batteries.

### <Negative Electrode Collector>

The material used for the negative electrode collector is not particularly restricted, and any one that can be used as a negative electrode collector for a battery may be employed as appropriate, examples including, but not being limited to, stainless steel (SUS), aluminum, copper, nickel, iron, titanium, carbon and resin current collectors.

The form of the negative electrode collector is not particularly restricted and may be, for example, a foil, sheet or mesh. A foil is preferred among these.

### <Negative Electrode Active Material Layer>

The negative electrode active material layer may be a layer formed by drying and removing the dispersing medium in the negative electrode mixture slurry of the disclosure that has been coated onto a substrate. If the electrolyte layer is a layer formed by drying and removal of the dispersing medium in the solid electrolyte mixture slurry of the disclosure which has been coated onto a substrate, and/or the positive electrode active material layer is a layer formed by drying and removal of the dispersing medium in the positive electrode mixture slurry of the disclosure which has been coated onto a substrate, then the negative electrode active material layer may be any one commonly used as a negative electrode active material layer for batteries.

### <Electrolyte Layer>

When the battery is a solid-state battery, the electrolyte layer may be a layer formed by drying and removal of the dispersing medium in the solid electrolyte mixture slurry of the disclosure which has been coated onto a substrate. When the battery is a solid-state battery and the negative electrode active material layer is a layer formed by drying and removal of the dispersing medium in the negative electrode mixture slurry of the disclosure which has been coated onto a substrate, and/or the positive electrode active material layer is a layer formed by drying and removal of the dispersing medium in the positive electrode mixture slurry of the disclosure which has been coated onto a substrate, then the electrolyte layer may be any one commonly used as an electrolyte layer for solid-state batteries. When the battery is a liquid battery, the electrolyte layer is a layer formed by impregnating a separator with the electrolyte solution. The separator and electrolyte solution are not particularly restricted, and may be ones that are commonly used as separators and electrolyte solutions for batteries.

### <Positive Electrode Active Material Layer>

The positive electrode active material layer may be a layer formed by drying and removing the dispersing medium in the positive electrode mixture slurry of the disclosure that has been coated onto a substrate. If the negative electrode active material layer is a layer formed by drying and removal of the dispersing medium in the negative electrode mixture slurry of the disclosure which has been coated onto a substrate, and/or the electrolyte layer is a layer formed by drying and removal of the dispersing medium in the solid electrolyte mixture slurry of the disclosure which has been coated onto a substrate, then the positive electrode active material layer may be any one commonly used as a positive electrode active material layer for batteries.

### <Positive Electrode Collector>

The material and form of the positive electrode collector are not particularly restricted, and may be decided with reference to the aforementioned description regarding the negative electrode active material layer of the disclosure. For example, the material of the positive electrode collector may be aluminum. The form may be a foil form.

### EXAMPLES

### <Examples 1 to 3, Comparative Examples 1 to 3 and Reference Example 1>

### <Preparation of Negative Electrode Mixture Slurry>

### (Step of Providing Preliminary Negative Electrode Mixture Slurry and Stirring Step)

Negative electrode mixture slurries for Examples 1 to 3 and Comparative Examples 1 and 2 were prepared by mixing a lithium titanate (LTO)-based negative electrode active material, a sulfide-based solid electrolyte, vapor-deposited carbon fiber (VGCF) as a conductive aid, a PVdF-based binder and butyl butyrate as a dispersing medium, using an ultrasonic disperser, and further mixing the components with a stirring blade. The negative electrode mixture slurry of Comparative Example 3 was the slurry before mixing with ultrasonic waves.

### (Step of Forming Negative Electrode Active Material Layer)

The obtained negative electrode mixture slurry was coated onto aluminum (Al) foil by the blade method, and dried at 100° C. on a hot plate over a period of 30 minutes, to obtain a negative electrode active material layer (coated film).

A slurry for Reference Example 1 was obtained in the same manner as Examples 1 to 3 and Comparative Examples 1 and 2, except that no negative electrode active material or conductive aid was used.

### <Evaluation>

### (Dispersity)

A time-domain nuclear magnetic resonance (TDNMR) apparatus (Minispec mq20 by Bruker Co.) was used to measure the relaxation time (T₂) for the negative electrode mixture slurry of each Example, and the dispersity of the components in each slurry was evaluated. The relaxation time was measured by the CPMG method. The relaxation time was calculated in terms of the indicated value using the TDNMR-A data analysis software included with the TDNMR apparatus. Specifically, the ratio of the relaxation time of the negative electrode mixture slurry was calculated with respect to the relaxation time of butyl acetate as the dispersing medium, to determine the relative value.

As a reference value, the point at which particles began to appear was observed during the fineness gauge method, and the value read off was used as an evaluation of the dispersity of the components in the slurry. The measurement was conducted based on JIS K 5600-2-5:1999.

### (Coated Film Properties)

The outward appearance of the negative electrode active material layer (coated film) was visually inspected, and the presence of any aggregates of gauge 0.5 mm or more was confirmed. Cases where aggregates were not confirmed were evaluated as “G”, and cases where aggregates were confirmed were evaluated as “P”.

### <Results>

The relaxation times and coated film properties, and the dispersities by the fineness gauge method as reference values are shown in Table 1.

TABLE 1

| | Relaxation time | Coated | Dispersity [μm] by |
|---|---|---|---|
| | (converted | film | fineness gauge method |
| | value) | properties | (reference value) |
| Example 1 | 0.018 | G | 25 |
| Example 2 | 0.024 | G | 25 |
| Example 3 | 0.025 | G | 30 |
| Comp. Example 1 | 0.027 | P | 25 |
| Comp. Example 2 | 0.028 | P | 20 |
| Comp. Example 3 | 0.190 | P | 45 |
| Ref. Example 1 | 0.470 | — | — |

As seen in Table 1, the dispersities of the negative electrode mixture slurries of the Examples by the fineness gauge method were equal to or more than the values of Comparative Examples 1 and 2, but the relaxation times measured with a TDNMR apparatus were within the predetermined range, indicating satisfactory properties of the obtained coated films. With the unstirred Comparative Example 3, the dispersity determined by the fineness gauge method and the relaxation time were both larger than the values in the Examples and Comparative Examples 1 and 2.

Since the relaxation time of the slurry of the Reference Example which did not comprise a negative electrode active material was significantly greater than the relaxation times of the negative electrode mixture slurries of the Examples and Comparative Examples, this suggests that the relaxation times of the Examples and Comparative Examples were due to the dispersities of the negative electrode active materials.

### <Examples 4 to 6, Comparative Examples 4 to 6 and Reference Example 2>

### <Preparation of Solid Electrolyte Mixture Slurry>

### (Step of Providing Preliminary Solid Electrolyte Mixture Slurry and Stirring Step)

Solid electrolyte composite slurries for Examples 4 to 6 and Comparative Examples 4 and 5 were prepared by mixing a sulfide-based solid electrolyte, a PVdF-based binder and butyl butyrate as a dispersing medium, using an ultrasonic disperser, and further mixing the components with a stirring blade. The solid electrolyte mixture slurry of Comparative Example 6 was the slurry before mixing with ultrasonic waves.

### (Step of Forming Solid Electrolyte Layer)

A solid electrolyte layer (coated film) was formed by the same method, except that a solid electrolyte mixture slurry was used instead of the negative electrode mixture slurry in the step of forming the negative electrode active material layer.

A slurry was prepared for Reference Example 2 by using a stirrer to mix a PVdF-based binder and butyl butyrate as the dispersing medium.

### <Evaluation>

### (Dispersity)

The relaxation time (T₂) of each solid electrolyte mixture slurry was measured in the same manner as when using the negative electrode mixture slurry, except that the solid electrolyte composite slurries of each of the Examples were used instead of the negative electrode mixture slurry, and the dispersity of the solid electrolyte in the slurry was evaluated.

### (Coated Film Properties)

The coated film properties were evaluated in the same manner as for the negative electrode active material layer, except that a solid electrolyte layer was used instead of a negative electrode active material layer for the coated film.

### <Results>

Table 2 shows the relaxation times and coated film properties, and the dispersities determined by the fineness gauge method as reference values.

TABLE 2

| | Relaxation time | Coated | Dispersity [μm] by |
|---|---|---|---|
| | (converted | film | fineness gauge method |
| | value) | properties | (reference value) |
| Example 4 | 0.46 | G | 30 |
| Example 5 | 0.48 | G | 30 |
| Example 6 | 0.49 | G | 35 |
| Comp. Example 4 | 0.52 | P | 30 |
| Comp. Example 5 | 0.54 | P | 25 |
| Comp. Example 6 | 0.83 | P | 50 |
| Ref. Example 2 | 0.84 | — | — |

As seen in Table 2, even though the dispersities of the solid electrolyte composite slurries of the Examples by the fineness gauge method were equal to or more than the values of Comparative Examples 4 and 5, the relaxation times measured with a TDNMR apparatus were within the predetermined range, indicating satisfactory properties of the obtained coated films. With the unstirred Comparative Example 6, the dispersity determined by the fineness gauge method and the relaxation time were both larger than the values in the Examples and Comparative Examples 4 and 5.

Since the relaxation time of the slurry of the Reference Example which did not comprise a solid electrolyte was significantly greater than the relaxation times of the solid electrolyte composite slurries of the Examples and Comparative Examples, this suggests that the relaxation times of the Examples and Comparative Examples were due to the dispersities of the solid electrolytes.

### <Examples 7 to 9 and Comparative Examples 7 to 9>

### <Preparation of Positive Electrode Mixture Slurry>

### (Step of Providing Preliminary Positive Electrode Mixture Slurry and Stirring Step)

Positive electrode mixture slurries for Examples 7 to 9 and Comparative Examples 7 and 8 were prepared by mixing an NCA-based positive electrode active material, a sulfide-based solid electrolyte, vapor-deposited carbon fiber (VGCF) as a conductive aid, a PVdF-based binder and butyl butyrate as a dispersing medium, using an ultrasonic disperser, and further mixing the components with a stirring blade. The positive electrode mixture slurry of Comparative Example 9 was the slurry before mixing with ultrasonic waves.

### (Step of Forming Positive Electrode Active Material Layer)

A positive electrode active material layer (coated film) was formed by the same method, except that a positive electrode mixture slurry was used instead of the negative electrode mixture slurry in the step of forming the negative electrode active material layer.

### <Evaluation>

### (Dispersity)

The relaxation time (T₂) of each positive electrode mixture slurry was measured in the same manner as for the negative electrode mixture slurry, except that the positive electrode mixture slurries of each of the Examples were used instead of the negative electrode mixture slurry, and the dispersity of the positive electrode active material in the slurry was evaluated.

### (Coated Film Properties)

The coated film properties were evaluated in the same manner as when using a negative electrode active material layer, except that a positive electrode active material layer was used instead of a negative electrode active material layer for the coated film.

### <Results>

Table 3 shows the relaxation times and coated film properties, and the dispersities determined by the fineness gauge method as reference values.

TABLE 3

| | Relaxation time | Coated | Dispersity [μm] by |
|---|---|---|---|
| | (converted | film | fineness gauge method |
| | value) | properties | (reference value) |
| Example 7 | 5.2 × 10⁻⁵ | G | 35 |
| Example 8 | 4.9 × 10⁻⁵ | G | 35 |
| Example 9 | 4.7 × 10⁻⁵ | G | 40 |
| Comp. Example 7 | 5.5 × 10⁻⁵ | P | 35 |
| Comp. Example 8 | 5.6 × 10⁻⁵ | P | 30 |
| Comp. Example 9 | 7.5 × 10⁻⁵ | P | 60 |

As seen in Table 3, even though the dispersities of the positive electrode mixture slurries of the Examples determined by the fineness gauge method were equal to or more than the values of Comparative Examples 7 and 8, the relaxation times measured with a TDNMR apparatus were within the predetermined range, indicating satisfactory properties of the obtained coated films. With the unstirred Comparative Example 9, the dispersity determined by the fineness gauge method and the relaxation time were both larger than the values in the Examples and Comparative Examples 7 and 8.

1. An evaluation method for a slurry for batteries, comprising measuring the relaxation time of the slurry for batteries using a time-domain nuclear magnetic resonance apparatus to evaluate the dispersity of specific components contained in the slurry for batteries.

2. The method according to claim 1, wherein the slurry for batteries is a negative electrode mixture slurry, and the specific component is a negative electrode active material.

3. The method according to claim 2, wherein the relaxation time is measured by the CPMG method.

4. A method for producing a negative electrode mixture slurry, the method comprising the following steps:
(a) providing a preliminary negative electrode mixture slurry containing a negative electrode active material and a dispersing medium,
(b) stirring the preliminary negative electrode mixture slurry, and
(c) evaluating the dispersity of the negative electrode active material in the negative electrode mixture slurry by the method according to claim 2.

5. The method according to claim 4, wherein in step (c), steps (b) and (c) are repeated until the converted value of the relaxation time of the negative electrode mixture slurry as measured by the CPMG method is 0.015 or more and 0.025 or less, in terms calculated based on the relaxation time of the dispersing medium.

6. The method according to claim 4, wherein the mean particle diameter of the negative electrode active material is 10 nm or more and 50 μm or less.

7. A method for producing a battery, comprising the following steps:
providing a negative electrode mixture slurry by the method according to claim 4, and
coating the negative electrode mixture slurry onto a substrate and drying and removing the dispersing medium to form a negative electrode active material layer.

8. A negative electrode mixture slurry wherein the converted value of the relaxation time as measured by the CPMG method using a time-domain nuclear magnetic resonance apparatus, is 0.015 or more and 0.025 or less in terms calculated based on the relaxation time of the dispersing medium.

9. The method according to claim 1, wherein the slurry for batteries is a solid electrolyte mixture slurry, and the specific component is a solid electrolyte.

10. The method according to claim 9, wherein the relaxation time is measured by the CPMG method.

11. A method for producing a solid electrolyte mixture slurry, the method comprising the following steps:
(a) providing a preliminary solid electrolyte mixture slurry containing a solid electrolyte and a dispersing medium,
(b) stirring the preliminary solid electrolyte mixture slurry, and
(c) evaluating the dispersity of the solid electrolyte in the solid electrolyte mixture slurry by the method according to claim 9.

12. The method according to claim 11, wherein in step (c), steps (b) and (c) are repeated until the converted value of the relaxation time of the solid electrolyte mixture slurry as measured by the CPMG method is 0.45 or more and 0.50 or less, in terms calculated based on the relaxation time of the dispersing medium.

13. The method according to claim 11, wherein the mean particle diameter of the solid electrolyte is 1 nm or more and 10 μm or less.

14. A method for producing a battery, comprising the following steps:
providing a solid electrolyte mixture slurry by the method according to claim 11, and
coating the solid electrolyte mixture slurry onto a substrate and drying and removing the dispersing medium to form a solid electrolyte layer.

15. A solid electrolyte mixture slurry wherein the converted value of the relaxation time as measured by the CPMG method using a time-domain nuclear magnetic resonance apparatus, is 0.45 or more and 0.50 or less in terms calculated based on the relaxation time of the dispersing medium.

16. The method according to claim 1, wherein the slurry for batteries is a positive electrode mixture slurry, and the specific component is a positive electrode active material.

17. The method according to claim 16, wherein the relaxation time is measured by the solid echo method.

18. A method for producing a positive electrode mixture slurry, the method comprising the following steps:
(a) providing a preliminary positive electrode mixture slurry containing a positive electrode active material and a dispersing medium,
(b) stirring the preliminary positive electrode mixture slurry, and
(c) evaluating the dispersity of the positive electrode active material in the positive electrode mixture slurry by the method according to claim 16.

19. The method according to claim 18, wherein in step (c), steps (b) and (c) are repeated until the converted value of the relaxation time of the positive electrode mixture slurry as measured by the solid echo method, is 4.5×10⁻⁵ or more and 5.4×10⁻⁵ or less, in terms calculated based on the relaxation time of the dispersing medium.

20. The method according to claim 18, wherein the mean particle diameter of the positive electrode active material is 10 nm or more and 50 μm or less.

21. A method for producing a battery, comprising the following steps:
providing a positive electrode mixture slurry by the method according to claim 18, and
coating the positive electrode mixture slurry onto a substrate and drying and removing the dispersing medium to form a positive electrode active material layer.

22. A positive electrode mixture slurry wherein the converted value of the relaxation time as measured by the solid echo method using a time-domain nuclear magnetic resonance apparatus, is 4.5×10⁻⁵ or more and 5.4×10⁻⁵ or less, in terms calculated based on the relaxation time of the dispersing medium.
